(19) United States
(12) Patent Application Publication
(10) Pub. No.: US 2012/0210702 A1
(43) Pub. Date: Aug. 23, 2012

(54) CATALYTIC CONVERTER DEVICE

(76) Inventors: Uwe Thesling, Borken (DE); Holger Gräf, Borken (DE)

(21) Appl. No.: 13/390,006

(22) PCT Filed: Jul. 5, 2010
(86) PCT No.: PCT/EP2010/004059

§ 371 Date: Apr. 26, 2012

(30) Foreign Application Priority Data
Aug. 12, 2009 (DE) 102009037271.7

(51) Int. Cl. F01N 3/28; B23P 11/00

(52) U.S. Cl. 60/299; 29/890

(57) ABSTRACT

The invention relates to a catalytic converter device for an internal combustion engine that produces exhaust gas, comprising a catalytic converter body (3) through which the exhaust gas can flow, a housing shell (2) that surrounds the catalytic converter body (3), and an apparatus for retaining the catalytic converter body (3) inside the housing shell (2). According to the invention, the apparatus for retaining has a joining foam (6), which connects the catalytic converter body (3) to the housing shell (2). The invention further relates to a method for producing such a catalytic converter device.

The present invention relates to a catalytic converter device for an internal combustion engine that produces exhaust gas, comprising a catalytic converter body through which the exhaust gas can flow, a housing shell that surrounds the catalytic converter body, and a means for holding the catalytic converter body inside the housing shell, according to the generic part of claim 1. The invention further relates to a method for producing such a catalytic converter device.

Catalytic converter devices are widely known in the state of the art. Thus, for example, German patent application DE 10 2006 035 957 A1 describes a catalytic converter device having a catalytic converter body that is held inside a catalytic converter housing. For purposes of holding the catalytic converter body inside the catalytic converter housing, an axial fabric ring is provided on the inlet side and an axial fabric ring is provided on the outlet side, said rings holding the catalytic converter body in the axial direction as well as in the radial direction of the catalytic converter housing. A mounting mat or intumescent mat is provided between the axial fabric ring on the inlet side and the axial fabric ring on the outlet side in the space between the outer circumferential surface of the catalytic converter body having a certain outer diameter and the inner circumferential surface of the catalytic converter housing having a certain inner diameter, this mat being separated from the catalytic converter body by a layer of Insulfrax paper. The two axial fabric rings and the layer of Insulfrax paper prevent exhaust gases from penetrating into the mounting mat or intumescent mat, so that the exhaust gases pass through the entire extension of the catalytic converter body in the direction of flow of the exhaust gases.

When intumescent mats are used in the catalytic converter devices, however, high precision and accuracy are required during the production since these mats have a very specific intumescent behavior. The dimension of the gap that creates a space between the catalytic converter body and the catalytic converter housing has to be precisely observed so that, after an intumescence process, the intumescent mat holds and mounts the catalytic converter body in the desired manner. If the dimension of the gap is too small, that is to say, if insufficient volume is available for the swelling or expansion of the intumescent mat during the intumescence process, then the catalytic converter body can be damaged due to excessive forces acting upon it. On the other hand, if the dimension of the gap is too large, the forces exerted are inadequate, as a result of which it is not ensured that the catalytic converter body will be held or mounted stably.

Before this backdrop, the objective of the present invention is to refine prior-art catalytic converter devices and their production methods in such a way that subsequently, the catalytic converter body can easily be held stably.

This objective is achieved by a catalytic converter device having the features of claim 1 and by a method for producing such a catalytic converter device, having the features of claim 8.

In a catalytic converter device of the type described above, it is provided according to the invention that the holding device has a joining foam that joins the catalytic converter body to the housing shell. The method according to the invention for producing the catalytic converter device provides that a catalytic converter body is installed in a housing shell and subsequently, the space formed between the catalytic converter body and the housing shell is filled with a joining foam.

The essence of the invention is that the space that is always present between the catalytic converter body and the catalytic converter housing, irrespective of the precise dimension of its gap, is filled with the joining foam instead of with the generally known intumescent mat, and no damaging forces act upon the catalytic converter body. By dispensing with the intumescent mat, the drawbacks associated with it are overcome. As a result, it is no longer necessary to precisely observe the dimension of the gap, which simplifies the construction of the catalytic converter device and its production, thus reducing the costs.

In order for the catalytic converter body to be sturdily and securely held in the catalytic converter housing and in order for the joining foam to have a high strength, the joining foam is preferably made with stainless steel as its basic material.

In an advantageous manner, the joining foam for the catalytic converter device according to the invention has a closed-cell structure. On the one hand, this means that the exhaust gas cannot flow through the joining foam but rather only through the catalytic converter body, and on the other hand, the gas entrapped in the foam provides a thermally insulating effect. As a result, additional heat-protection measures that entail higher costs can be reduced or dispensed with altogether.

In order to create suitable and large gas inclusions in the joining foam according to the invention, it is preferably foamed by an expanding agent containing titanium hydride.

In order to provide the joining foam with a specific flexibility and elasticity so that it holds the catalytic converter body in a shock-absorbing manner, and in order to bridge different coefficients of thermal expansion of the different materials employed, admixtures of oxide, nitride, ceramic and/or composite materials can be added to the joining foam of the catalytic converter device according to the invention.

In order to ensure the proper function and strength of the joining foam, it has a long-term thermal stability of preferably at least 500° C. [932° F]. In particular, the joining foam has a long-term thermal stability that is preferably at least 650° C. [1202° F].

Below, the present invention is explained in greater depth on the basis of the detailed description of an embodiment, making reference to the accompanying single figure.

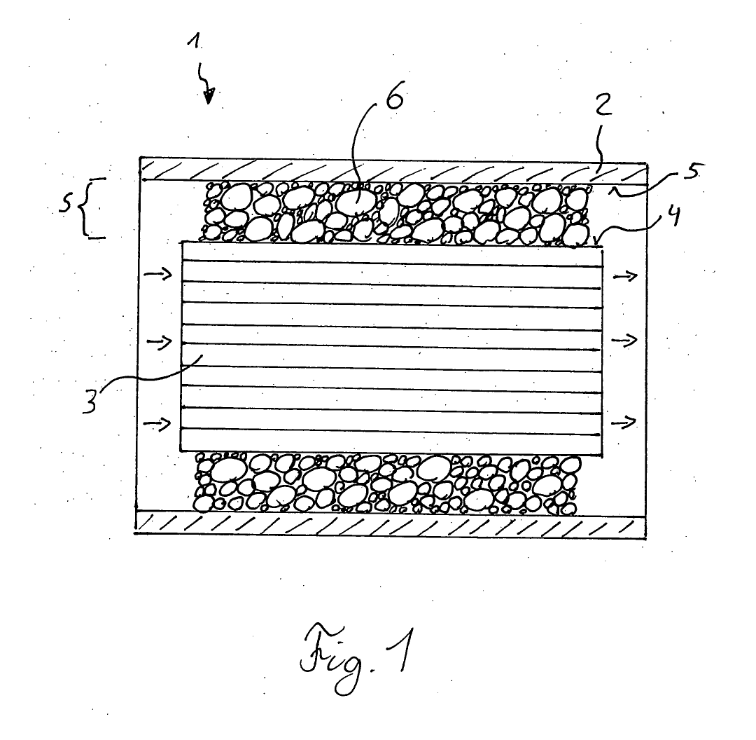

FIG. 1 shows a cross section of the catalytic converter device 1 according to the invention, with a housing shell 2. Inside the housing shell 2, there is a catalytic converter body 3 or monolith through which exhaust gases from an internal combustion engine (not shown here) can flow. The direction of flow of the exhaust gases is indicated by the arrows in FIG. 1.

There is a space with a gap dimension S between an outer surface 4 of the catalytic converter body 3 and an inner surface 5 of the housing shell 2. In the area of the gap, the space between the catalytic converter body 3 and the housing shell 2 is filled with a joining foam 6 that provides a secure and strong connection between the inside 5 of the housing shell 2 and the outer surface 4 of the catalytic converter body 3. Thanks to the relatively large, closed-cell structure of the joining foam 6 and due to the gas inclusions, the joining foam brings about a thermally insulating effect between the catalytic converter body 3 and the housing shell 2. Moreover, the closed-cell structure prevents the exhaust gas from flowing through the joining foam 6, so that the entire stream of exhaust gas has to pass through the catalytic converter body 3.

The catalytic converter device 1 can be arranged in an exhaust gas system in a suitable manner. In particular, the housing shell 2 can be closed, at least partially, at its inlet or outlet side by means of suitable covers (not shown here).

The depiction in FIG. 1 clearly shows that the joining foam 6 fulfills its functions of holding the catalytic converter body 3, of providing thermal insulation, and of compensating for tolerances in the gap dimension S. Moreover, thanks to a specific flexibility and elasticity of the joining foam 6, which are attained by using suitable admixtures, impact and vibrations can be absorbed, so that the joining foam 6 additionally serves to protect the catalytic converter body against damage.

List of reference numerals
1 catalytic converter device
2 housing shell
3 catalytic converter body
4 outer surface
5 inner surface
6 joining foam
S gap dimension

1. A catalytic converter device for an internal combustion engine that produces exhaust gas, comprising:
a catalytic converter body through which the exhaust gas can flow,
a housing shell that surrounds the catalytic converter body, and
a means for holding the catalytic converter body inside the housing shell,
wherein the holding device has a joining foam that joins the catalytic converter body to the housing shell.

2. The catalytic converter device according to claim 1, wherein the joining foam is made of stainless steel as its basic material.

3. The catalytic converter device according to claim 1, wherein the joining foam has a closed-cell structure.

4. The catalytic converter device according to claim 1, wherein the joining foam is foamed by an expanding agent containing titanium hydride.

5. The catalytic converter device according to claim 1, wherein the joining foam contains admixtures of oxide, nitride, ceramic and/or composite materials.

6. The catalytic converter device according to claim 1, wherein the joining foam has a long-term thermal stability of at least 500° C. [932° F].

7. The catalytic converter device according to claim 6, wherein the joining foam has a long-term thermal stability of at least 650° C. [1202° F].

8. A method for producing a catalytic converter device, comprising:
installing a catalytic converter body in a housing shell; and
filling a space formed between the catalytic converter body and the housing shell with a joining foam.
